(19) United States
(12) Patent Application Publication
(10) Pub. No.: US 2023/0412475 A1
(43) Pub. Date: Dec. 21, 2023

(54) EXTRACTING CORRECTIVE ACTIONS FROM INFORMATION TECHNOLOGY OPERATIONS

(71) Applicant: INTERNATIONAL BUSINESS MACHINES CORPORATION, ARMONK, NY (US)

(72) Inventors: Boris Sobolev, Berkeley, CA (US); Yu Deng, Yorktown Heights, NY (US); Md Faisal Mahbub Chowdhury, Woodside, NY (US); Paulina Toro Isaza, White Plains, NY (US)

(21) Appl. No.: 17/807,738

(22) Filed: Jun. 20, 2022

(51) Int. Cl. H04L 41/5074; H04L 41/16; H04L 41/0631; G06F 40/30; G06K 9/62

(52) U.S. Cl. CPC H04L 41/5074; H04L 41/16; H04L 41/065; G06F 40/30; G06K 9/6215

(57) ABSTRACT

A computer-implemented method, a computer system and a computer program product create a database of corrective actions from IT operations. The method includes obtaining a plurality of tickets from a server. A ticket in the plurality of tickets comprises text. The method also includes generating a plurality of clusters of tickets from the plurality of tickets using a machine learning clustering algorithm. In addition, the method includes identifying the corrective action in the text of the ticket using a natural language processing algorithm. The method further includes determining that the corrective action represents a successful action. lastly, the method includes storing the corrective action in the database of corrective actions, where the database associates the corrective action with the cluster of tickets.

### BACKGROUND

Embodiments relate generally to the field of resolving information technology (IT) tickets, and more specifically, to extracting corrective actions from ticket data and creating a database of corrective actions.

Many business organizations provide help desks to assist customers who have questions or problems with the business organization's products or services. Such a help desk may utilize a ticketing system to record operations and also assist with more efficient resolution of customer issues in information technology (IT) environments. Tickets, also referred to as records or cases, within such systems may be used to track operations used to resolve IT issues and also record detailed information about the systems involved. Most importantly, information about the actions that may be taken in past tickets to resolve particular issues may be used to determine solutions to current tickets, or cases.

### SUMMARY

An embodiment is directed to a computer-implemented method for creating a database of corrective actions from IT operations. The method may include obtaining a plurality of tickets from a server, where a ticket in the plurality of tickets comprises text. The method may also include generating a plurality of clusters of tickets from the plurality of tickets using a machine learning clustering algorithm. In addition, the method may include identifying the corrective action in the text of the ticket using a natural language processing algorithm. The method may further include determining that the corrective action represents a successful action. Lastly, the method may include storing the corrective action in the database of corrective actions, where the database associates the corrective action with the cluster of tickets.

In another embodiment, the method may include mapping the ticket to a cluster of tickets in the plurality of clusters of tickets.

In a further embodiment, mapping the ticket to the cluster may include calculating a semantic distance between the cluster and the ticket and adding the ticket to the cluster of tickets when the semantic distance is below a threshold.

In yet another embodiment, the method may include determining a similarity between the corrective action and an action in the database of corrective actions, where the action is associated with the cluster. In this embodiment, the method may also include modifying the corrective action when the similarity of the corrective action to the action is below a threshold.

In another embodiment, the machine learning clustering algorithm may be a density-based spatial clustering of applications with noise (DBSCAN) clustering algorithm.

In yet another embodiment, a machine learning model that predicts sentiment in an information exchange based on text sequences may be used to determine if the corrective action is successful.

In a further embodiment, generating a cluster of tickets may include calculating a semantic distance between two tickets and clustering the two tickets in the cluster of tickets when the semantic distance is below a threshold.

In addition to a computer-implemented method, additional embodiments are directed to a computer system and a computer program product for creating a database of corrective actions from IT operations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for creating a database of corrective actions from IT operations.

FIG. 3 depicts a cloud computing environment according to an embodiment.

FIG. 4 depicts abstraction model layers according to an embodiment.

### DETAILED DESCRIPTION

In a standard information technology (IT) environment, when an end user contacts an IT professional to report an issue, the reported issue may be described in the form of symptoms demonstrated from the user's perspective such as, for example, an identifier of an error message, inability to access a service, inability to start a system or program, and the like. For example, the user may call or email an IT professional to say that the workstation takes very long to log in or may do so via a service portal. Alternatively, in a data center, an IT professional may need to upgrade the version of a software package. To create and store a record of the issue or IT operation, a ticket may be created in an IT service management system for the issue and the tickets may be used to investigate and resolve issues that arise through this process. Such ticketing systems may track the communications between individuals, users, groups, teams, organizations, and businesses in interaction spaces such as support, user service, sales, engineering, and information technology.

A customer may seek technical help when submitting a ticket for a software product and may expect a context-specific dialogue with an IT professional who may diagnose the problem through pointed questions and drives prompt problem resolution. Swift resolution of problems results in happy customers who would then continue to use the software product, ultimately the primary focus of any IT organization. Additionally, by providing useful knowledge and tools for solving customer problems to IT professionals, an IT organization enables these IT professionals to feel satisfied with their work, thereby reducing churn in IT professionals and the need to spend the IT organization's resources on training many new IT professionals.

For more efficient IT operations, it may be useful to provide an automated method or system to mine historical tickets and automatically extract actions that led to a successful resolution of a problem based on the contextual clues in the text of the ticket. Text fields in tickets may contain valuable insights on an IT operation, e.g., context of the issues and actions taken in historical support interactions that may have involved the same IT system or software. However, such textual data is unlabeled, domain/system specific and often ungrammatical.

Such a method may consist of both an offline and an online processing component that may extract corpus-specific common verb sequences and perform sentiment analysis. In addition, tickets may be clustered based on content and semantic structure to account for domain specific data distribution imbalances. and a dynamic vocabulary may be used to account for domain specific terms. The clusters may also be utilized to improve candidate sequences and gain a better understanding of used data.

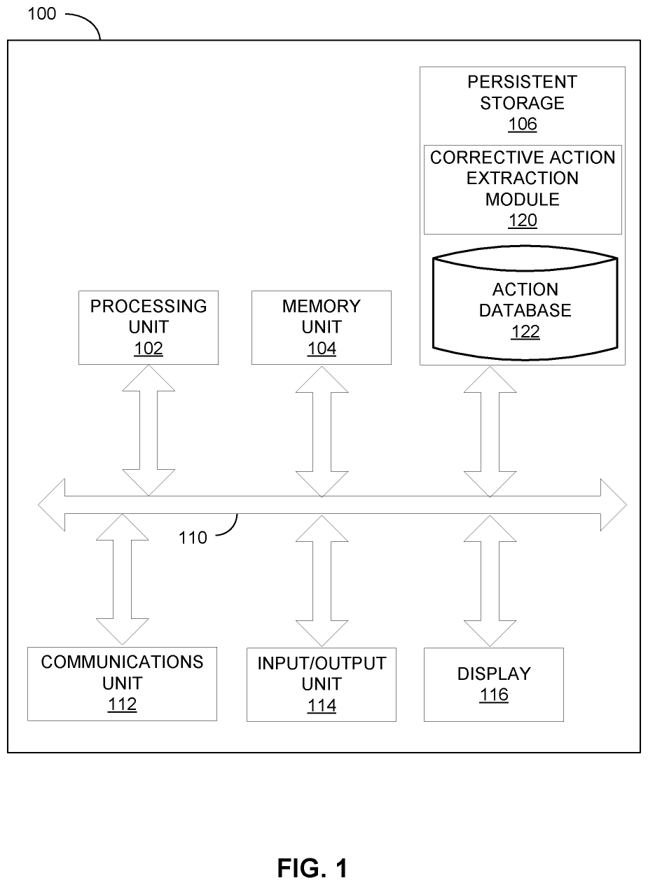

Referring now to FIG. 1, there is shown a block diagram illustrating a computer system 100 in accordance with an embodiment. It should be appreciated that FIG. 1 provides only an illustration of one implementation and does not imply any limitations with regard to the environments in which different embodiments may be implemented. Many modifications to the depicted environments may be made based on design and implementation requirements. For example, computer system 100 may be implemented in hardware only, software only, or a combination of both hardware and software. Computer system 100 may have more or fewer components and modules than shown, may combine two or more of the components, or may have a different configuration or arrangement of the components. Computer system 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of computer system 100 may be co-located or distributed, or the system could run as one or more cloud computing “instances,” “containers,” and/or “virtual machines,” as known in the art.

As shown, a computer system 100 includes a processor unit 102, a memory unit 104, a persistent storage 106, a communications unit 112, an input/output unit 114, a display 116, and a system bus 110. Computer programs such as the corrective action extraction module 120 may be stored in the persistent storage 106 until they are needed for execution, at which time the programs are brought into the memory unit 104 so that they can be directly accessed by the processor unit 102. The processor unit 102 selects a part of memory unit 104 to read and/or write by using an address that the processor unit 102 gives to memory unit 104 along with a request to read and/or write. Usually, the reading and interpretation of an encoded instruction at an address causes the processor unit 102 to fetch a subsequent instruction, either at a subsequent address or some other address. The processor unit 102, memory unit 104, persistent storage 106, communications unit 112, input/output unit 114, and display 116 all interface with each other through the system bus 110.

Examples of computing systems, environments, and/or configurations that may be represented by the computer system 100 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computer system 100 may also include a communications unit 112 such as TCP/IP adapter cards, wireless Wi-Fi interface cards, or 3G or 4G wireless interface cards or other wired or wireless communication links. Communication between mobile devices may be accomplished via a network and respective network adapters or communication units 112. In such an instance, the communication network may be any type of network configured to provide for data or any other type of electronic communication. For example, the network may include a local area network (LAN), a wide area network (WAN), a virtual private network (VPN), a mobile or cellular telephone network, the Internet, or any other electronic communication system. The network may use a communication protocol, such as the transmission control protocol (TCP), the user datagram protocol (UDP), the internet protocol (IP), the real-time transport protocol (RTP) the Hyper Text Transport Protocol (HTTP), or a combination thereof.

The computer system 100 may be used for determining if corrective actions are successful and extracting those corrective actions from IT tickets that may be stored in a database or otherwise received by the computer system. In particular, a corrective action extraction module 120 may examine and parse the text of an IT ticket that is received, searching for a corrective action, which may be in the form of a sentence or phrase of text that may include an action verb, for example “rebooted” or “restarted”, as well as words that may be syntactically or semantically related to the action verb. An example of a corrective action may include “Compute squad performed OS patch and reboot on vSRX hosts”. The module 120 may use text recognition and natural language processing (NLP) algorithms known in the art to cluster the tickets that are received using different criteria, such as a domain, e.g., server, computer, operating system, network, etc. These clusters may be used by the module 120 in conjunction with corrective actions to narrow a list of corrective actions that may be kept by the module 120 in an action database 122.

Once clusters have been established by the module 120, the text of a received ticket may be searched and the module 120 may determine the cluster that is most related to the ticket, which may assist in finding a relevant corrective action. The module 120 may then locate a specific corrective action within the text of the ticket by locating an action verb corresponding to an action that may relate to resolving an issue along with related words to form a text sequence. As an example, in the sentence “Compute squad performed OS patch and reboot on vSRX hosts”, the relevant action verb may be “performed”, “OS patch and reboot” may be related to the action verb, i.e., what is “performed”, and “vSRX hosts” may also be related but may not be relevant outside the current ticket that may be analyzed. The module 120 may alter the text that may be in the ticket to improve understanding for later use, meaning that words that may be critical in the instant context of a support issue but not helpful outside that context may be dropped, in addition to elimination of other words or punctuation that may also not be relevant to the corrective action. The module 120 may then apply sentiment analysis, e.g., a deep learning model such as Bidirectional Encoder Representations from Transformers (BERT) that has been pre-trained, to separate out successful corrective actions. Successful corrective actions may then be stored in a database along with an indication of the cluster of the ticket in a database that may be used to provide assistance in subsequent IT operations.

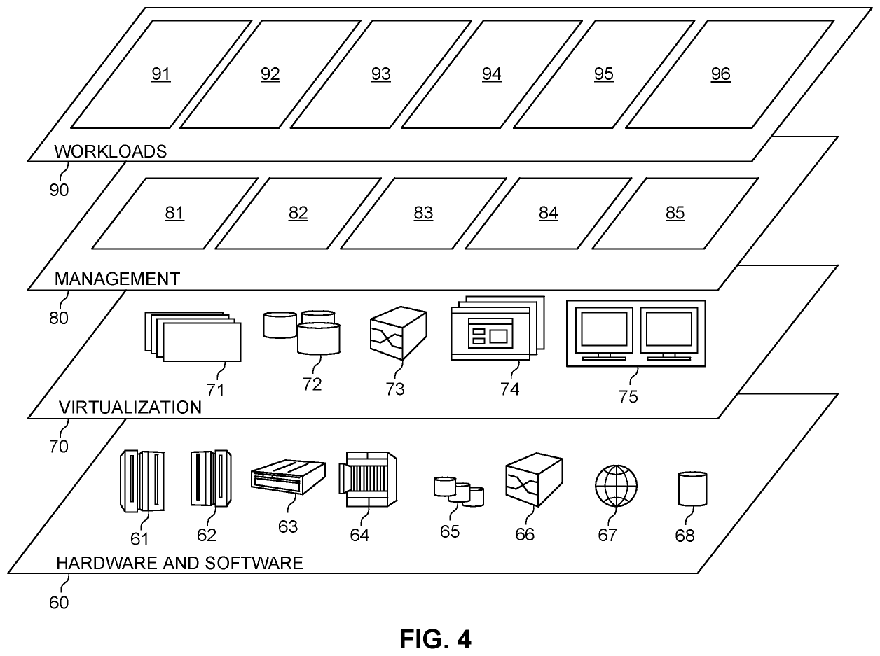

As will be discussed below with reference to FIGS. 4 and 5, computing system 100 may also operate in a cloud computing service model, such as Software as a Service (SaaS), Platform as a Service (PaaS), or Infrastructure as a Service (IaaS). Any computing system 100 may also be located in a cloud computing deployment model, such as a private cloud, community cloud, public cloud, or hybrid cloud.

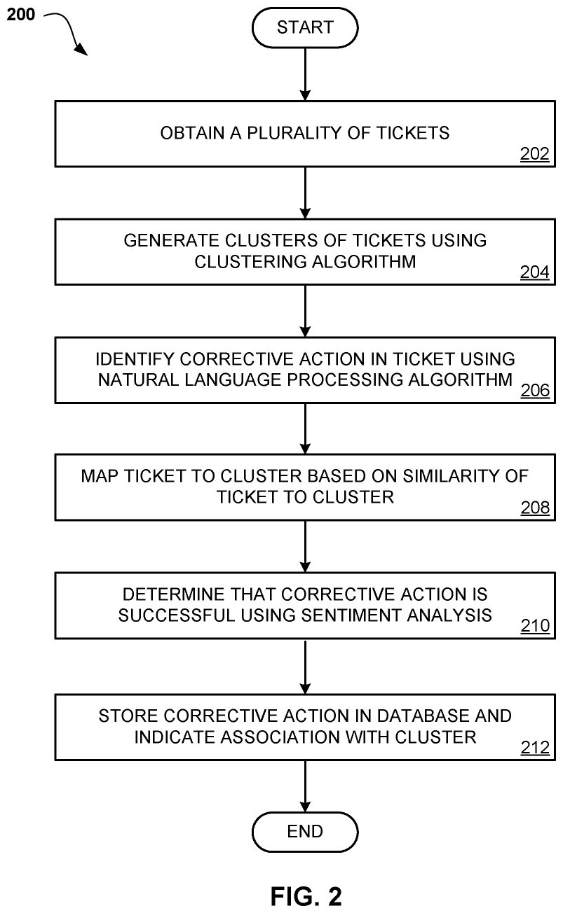

Referring to FIG. 2, an operational flowchart illustrating a process 200 for creating a database of corrective actions from IT operations is depicted according to at least one embodiment. At 202, a plurality of tickets may be obtained from a server. It should be noted that the term “ticket” is commonly used in the industry to refer to a record of an IT operation. For instance, an issue, such as a problem with operating a computer or other technology product, may be reported by the user to the organization, which may in turn log the report by the user and open a ticket. The ticket, and a unique identifier assigned to the ticket, may be used to provide updates on the issue if ongoing, or simply log individual actions taken with respect to the issue. Therefore, the ticket may be in the form of text and such text may be searched or recognized to provide information about the resolution of underlying issues. It should be noted that while text is the most common form for a ticket, if a file of any type has been attached to the ticket in the system, e.g., a scanned form that a user has filled out and sent to the IT organization, any such attachment may also be scanned at this stage and text read and recognized for inclusion in the ticket.

A ticket may be retrieved from a ticketing system, which refers to specific software that may be loaded and running on a computer, which may be computer system 100 or any other computer that may or may not be connected directly to computer system 100. The ticketing system may include a database of tickets corresponding to prior IT operations but may also include tickets that are more recent and noy yet included in a database. In addition, obtaining the ticket may include the use of text recognition algorithms to read and recognize textual information that may be included in the ticket and also the use of a text buffer to prepare for further processing, e.g., the natural language processing or clustering algorithms that are described in later steps of process 200.

At 204, the text of the tickets that may have been obtained with text recognition or other algorithms and possibly stored in the text buffer may be scanned for the purpose of generating clusters of tickets, where the clustering is done according to determined criteria such as domain or product or system. Such clustering may be done using a clustering algorithm that may be capable of detecting clusters of arbitrary shapes, e.g., density-based spatial clustering of applications with noise (DBSCAN). Such clustering may include calculating a distance metric, e.g., semantic distance, between pairs of tickets using semantic and structural linguistic features, such as count-based vectorization. A semantic distance between items may be based on the likeness of word meaning or semantic content as opposed to lexicographical similarity. Semantic distance is a mathematical tool used to estimate the strength of the semantic relationship between units of language, concepts or instances, through a numerical description obtained according to the comparison of information supporting meaning or describing the nature of the words or phrases being analyzed.

Computationally, semantic distance can be estimated by defining a topological similarity by using ontologies to define the distance between terms or concepts. The effectiveness of a semantic distance calculation may be evaluated based on the use of datasets designed by experts and composed of word pairs with semantic similarity degree estimation and also based on the integration of the measures inside specific applications. Lower semantic distance may indicate a higher level of similarity between the two objects of the calculation, in this case the text of each ticket in the pair of tickets being evaluated. Clusters of tickets may be formed such that any pair of tickets within the cluster may have a semantic distance below a threshold. It should be noted that the semantic distance calculation is not required for the formation of clusters, the only requirement may be that tickets processed at this step are clustered according to a distinguishing characteristic, such as the domain or a specific product or system.

At 206, once clusters have been generated and stored tickets assigned to the clusters, tickets may be mapped to specific clusters as the tickets are obtained. Using the text recognition algorithms and natural language processing that is described above in generating the clusters, additional tickets that may be obtained may also be analyzed according to a semantic distance calculation or other metric to locate a cluster that suits the new ticket best. This may be considered an “online” process, whereby tickets are analyzed at the time they are obtained, while the process as described in 202 may be considered “offline”, where existing tickets may first be clustered before additional tickets are added using the “online” process. The state of the ticket, whether the ticket relates to a historical transaction and resides on a server or other storage medium or whether the ticket is more recent and has not yet been stored in the server or other medium, may be the only difference between the “offline” and “online” processes other than the generation of clusters, which is also unique to the “offline” process.

At 208, a corrective action may be identified in an individual ticket. In this context, a corrective action may be any action that has been taken in the course of resolving the issue of the ticket, whether successful or not. The text of the ticket may be parsed and action verbs identified within the ticket, for instance “rebooted” or “restarted” or “enabled”, by a text recognition algorithm. The algorithm may have a predetermined list of action verbs for tickets in general or may have a list that is classified by domain or any criteria that may have been used in the clustering algorithm, which would mean that the list is specific to the cluster to which the ticket has been mapped in the previous step. However, it is not required that the action verb is in a list, but rather the process 200 may analyze the text in the ticket using a natural language processing algorithm known as a syntax analyzer and determine if words in the text are verbs or nouns or stop words, etc. Once an action verb has been identified, the surrounding words may also be checked to see if they are syntactically or semantically related to the action verb such that the additional words should be merged with the action verb to create a full text sequence that may represent the corrective action. In the example cited above, a corrective action may be “Compute squad performed OS patch and reboot on vSRX hosts”. In this example, “performed” may be identified as the action verb and “OS patch and reboot on vSRX hosts” may be the related words that should be connected to the action verb. This full text sequence would be the corrective action that is identified in the ticket. It should be noted that multiple corrective actions may be identified in a single ticket and there may be multiple groups of text in a ticket because, while there may be one or more interactions with the IT organization, many corrective actions may be taken during a single interaction and there may be many interactions. Likewise, an interaction with a user is not required for corrective action to be taken, as actions may be taken independent of a specific interaction or ticket, and IT professionals may take action without being in direct communication with an end user at the time the corrective action is taken. Because the text in individual tickets may be less formal, as the record of a conversation or independent action may be kept in shorthand or some other informal method, the text sequence that may be used to describe the corrective action may also be modified by the process 200 by computing a similarity metric with respect to corrective actions that may have been extracted from tickets in the same cluster as the current ticket being analyzed. The text sequence that may be identified at this step may also be extracted such that it may be stored in a database later in the process 200.

At 210, the text sequences, which may be modified or not, may be analyzed using a sentiment analyzer to predict whether the corrective action was also successful in the course of resolving the issue in the ticket. This may be as simple as detecting phrases such as “re-enabled zone successfully” or the like or may be more sophisticated in reviewing an exchange between two IT professionals or between an IT professional and a user to determine if the corrective action resolved the issue or did not. In an embodiment, the sentiment analyzer at this step may be a deep learning model such as Bidirectional Encoder Representations from Transformers (BERT) that has been pre-trained to understand sentiment in a conversation. In an embodiment, an ensemble machine learning technique may be employed that uses multiple machine learning algorithms together to assure better prediction when compared with the prediction of a single machine learning algorithm. In this embodiment, training data for the model may include prior IT operations or corrective actions extracted from tickets. This training data may be retrieved from one ticket or many tickets, including data that may be separated by clusters or some other criteria that may indicate corrective actions specific to certain situations. The prediction results may be stored in a database so that the data is most current, and the output would always be up to date.

At 212, those corrective actions that have been determined to be successful actions may be stored in a database, e.g., action database 122, and the cluster of the ticket from which the successful corrective action was extracted may be indicated in the database entry. As such, successful corrective actions may be saved for later use in support of similar products or software to assist in the resolution of new support issues. This indication of cluster may be used as mentioned above to assist with the extraction of text sequences from tickets that may be received at a later time. As an example of the later use of the database, if a new issue happens, the IT professional may look at the database of actions once a ticket has been mapped to a particular cluster and find a customized list of corrective actions that were successful and may be repeated to resolve the current issue that has been reported.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

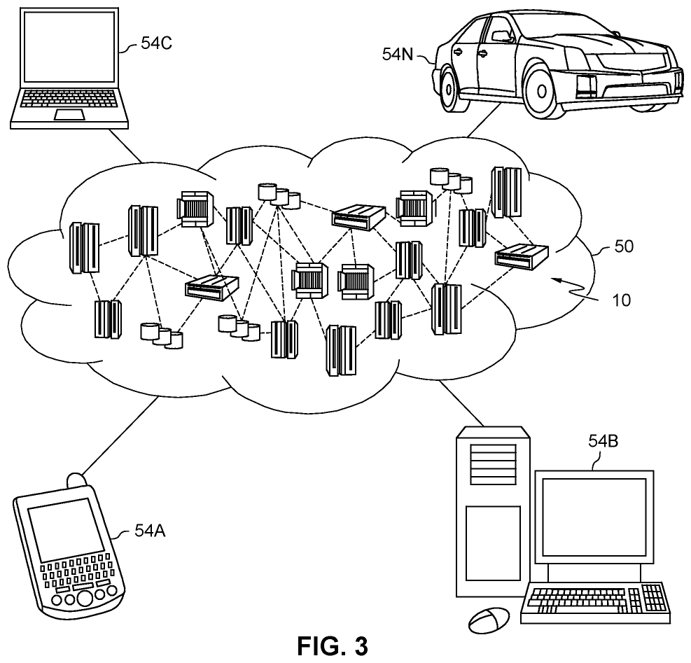

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and corrective action extraction 96, which may refer to determining corrective actions from IT operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for storing successful technical support actions from prior interactions with IT operations, the computer-implemented method comprising:
obtaining a prior ticket from a server, wherein the prior ticket comprises text;
identifying a domain and a corrective action in the prior ticket by parsing the text of the prior ticket using a natural language processing algorithm, wherein the corrective action comprises specific words in the text of the prior ticket;
generating a cluster of prior tickets using a machine learning clustering algorithm, wherein the cluster of prior tickets is associated with an identified domain;
determining a sentiment in parsed text of the prior ticket using a deep machine learning model, wherein the sentiment associates the corrective action with a successful resolution of the prior ticket; and
storing the specific words of the corrective action in a database of corrective actions, wherein the corrective action is associated with the cluster of tickets.

2. The computer-implemented method of claim 1, further comprising:
receiving a current ticket from a user, wherein the current ticket includes current text;
identifying a current domain in the current ticket by parsing the current text of the current ticket using the natural language processing algorithm; and
mapping the current ticket to the cluster of prior tickets associated with the current domain.

3. The computer-implemented method of claim 2, wherein the mapping the current ticket to the cluster of prior tickets further comprises:
calculating a semantic distance between the cluster of prior tickets and the current ticket; and
adding the current ticket to the cluster of prior tickets when the semantic distance is below a threshold.

4. The computer-implemented method of claim 1, further comprising:
determining a similarity between the corrective action and an action in the database of corrective actions, wherein the action is associated with the cluster of prior tickets; and
modifying the corrective action when the similarity of the corrective action to the action is below a threshold.

5. The computer-implemented method of claim 1, wherein the machine learning clustering algorithm is a density-based spatial clustering of applications with noise (DBSCAN) clustering algorithm.

6. The computer-implemented method of claim 1, wherein the deep machine learning model that is used to determine the sentiment in the parsed text of the prior ticket is a Bidirectional Encoder Representations from Transformers (BERT) model.

7. The computer-implemented method of claim 1, wherein the generating the cluster of prior tickets further comprises:
calculating a semantic distance between two tickets; and
clustering the two tickets in the cluster of prior tickets when the semantic distance is below a threshold.

8. A computer system for storing successful technical support actions from prior interactions with IT operations, the computer system comprising:
one or more processors, one or more computer-readable memories, one or more computer-readable storage media, and program instructions stored on at least one of the one or more computer-readable storage media for execution by at least one of the one or more processors via at least one of the one or more computer-readable memories, wherein the computer system is capable of performing a method comprising:
obtaining a prior ticket from a server, wherein the prior ticket comprises text;
identifying a domain and a corrective action in the prior ticket by parsing the text of the prior ticket using a natural language processing algorithm, wherein the corrective action comprises specific words in the text of the prior ticket;
generating a cluster of prior tickets using a machine learning clustering algorithm, wherein the cluster of prior tickets is associated with an identified domain;
determining a sentiment in parsed text of the prior ticket using a deep machine learning model, wherein the sentiment associates the corrective action with a successful resolution of the prior ticket; and
storing the specific words of the corrective action in a database of corrective actions, wherein the corrective action is associated with the cluster of tickets.

9. The computer system of claim 8, further comprising:
receiving a current ticket from a user, wherein the current ticket includes current text;
identifying a current domain in the current ticket by parsing the current text of the current ticket using the natural language processing algorithm; and
mapping the current ticket to the cluster of prior tickets associated with the current domain.

10. The computer system of claim 9, wherein the mapping the current ticket to the cluster of prior tickets further comprises:
calculating a semantic distance between the cluster of prior tickets and the current ticket; and
adding the current ticket to the cluster of prior tickets when the semantic distance is below a threshold.

11. The computer system of claim 8, further comprising:
determining a similarity between the corrective action and an action in the database of corrective actions, wherein the action is associated with the cluster of prior tickets; and
modifying the corrective action when the similarity of the corrective action to the action is below a threshold.

12. The computer system of claim 8, wherein the machine learning clustering algorithm is a density-based spatial clustering of applications with noise (DBSCAN) clustering algorithm.

13. The computer system of claim 8, wherein the deep machine learning model that is used to determine the sentiment in the parsed text of the prior ticket is a Bidirectional Encoder Representations from Transformers (BERT) model.

14. The computer system of claim 8, wherein the generating the cluster of prior tickets further comprises:
calculating a semantic distance between two tickets; and
clustering the two tickets in the cluster of prior tickets when the semantic distance is below a threshold.

15. A computer program product for storing successful technical support actions from prior interactions with IT operations, the computer program product comprising:
a computer-readable storage medium having program instructions embodied therewith, the program instructions executable by a processor to cause the processor to perform a method comprising:
obtaining a prior ticket from a server, wherein the prior ticket comprises text;
identifying a domain and a corrective action in the prior ticket by parsing the text of the prior ticket using a natural language processing algorithm, wherein the corrective action comprises specific words in the text of the prior ticket;
generating a cluster of prior tickets using a machine learning clustering algorithm, wherein the cluster of prior tickets is associated with an identified domain;
determining a sentiment in parsed text of the prior ticket using a deep machine learning model, wherein the sentiment associates the corrective action with a successful resolution of the prior ticket; and
storing the specific words of the corrective action in a database of corrective actions, wherein the corrective action is associated with the cluster of tickets.

16. The computer program product of claim 15, further comprising:
receiving a current ticket from a user, wherein the current ticket includes current text;
identifying a current domain in the current ticket by parsing the current text of the current ticket using the natural language processing algorithm; and
mapping the current ticket to the cluster of prior tickets associated with the current domain.

17. The computer program product of claim 16, wherein the mapping the ticket to the cluster further comprises:
wherein the mapping the current ticket to the cluster of prior tickets further comprises:
calculating a semantic distance between the cluster of prior tickets and the current ticket; and
adding the current ticket to the cluster of prior tickets when the semantic distance is below a threshold.

18. The computer program product of claim 15, further comprising:
determining a similarity between the corrective action and an action in the database of corrective actions, wherein the action is associated with the cluster of prior tickets; and
modifying the corrective action when the similarity of the corrective action to the action is below a threshold.

19. The computer program product of claim 15, wherein the deep machine learning model that is used to determine the sentiment in the parsed text of the prior ticket is a Bidirectional Encoder Representations from Transformers (BERT) model.

20. The computer program product of claim 15, wherein the generating the cluster of prior tickets further comprises:
calculating a semantic distance between two tickets; and
clustering the two tickets in the cluster of prior tickets when the semantic distance is below a threshold.
